(19) United States
(12) Patent Application Publication
(10) Pub. No.: US 2012/0319415 A1
(43) Pub. Date: Dec. 20, 2012

(54) SUBSTRATE TRANSFER HAND AND SUBSTRATE TRANSFER DEVICE INCLUDING THE SUBSTRATE TRANSFER HAND

(75) Inventors: Makoto FURUTA, Fukuoka (JP); Toru NAKAKO, Fukuoka (JP); Tetsuya YAMASAKI, Fukuoka (JP)

(73) Assignee: KABUSHIKI KAISHA YASKAWA DENKI, Kitakyushu-shi (JP)

(21) Appl. No.: 13/409,107

(22) Filed: Mar. 1, 2012

(30) Foreign Application Priority Data
Jun. 15, 2011 (JP) 2011-133403

(51) Int. Cl. B66C 1/10

(52) U.S. Cl. 294/81.5

(57) ABSTRACT

A substrate transfer hand for unloading and loading a substrate with respect to a cassette and transferring the substrate, includes: a first driven roller configured to be rotated by a drive mechanism provided in the cassette when the hand is coupled to the cassette along a substrate unloading/loading direction. The substrate transfer hand further includes: a flat support bar configured to be coupled to the cassette; a second driven roller provided in the support bar; and a rotation transmitting unit for transmitting rotation of the first driven roller to the second driven roller such that the second driven roller is rotated in the same direction as the first driven roller.

### CROSS-REFERENCE TO RELATED APPLICATIONS

The present application claims priority under 35 U.S.C. §119 to Japanese Patent Application No. 2011-133403 filed on Jun. 15, 2011. The contents of this application are incorporated herein by reference in their entirety.

### BACKGROUND OF THE INVENTION

1. Field of the Invention

The present invention relates to a substrate transfer hand and a substrate transfer device including the substrate transfer hand.

2. Description of the Related Art

Conventionally, there is known a substrate transfer device for transferring a flat substrate such as a glass substrate of a liquid crystal panel and loading/unloading it into/from a storage cassette.

The substrate transfer device includes a substrate transfer hand having a plurality of plate-like forks. The substrate transfer device is designed to transfer a substrate placed on the forks. Furthermore, the substrate transfer device loads/unloads the substrate into/from the storage cassette (hereinafter referred to as “cassette”) by inserting the forks into the cassette.

Typically, the cassette includes a box-shaped housing having an open side, and plural pairs of rack pieces provided in multiple stages on the mutually-facing side surfaces of the housing. Substrates are supported from below by the rack pieces of the respective stages, one substrate by each pair of rack pieces.

In recent years, in keeping with the mass production of large-size liquid crystal panel displays, there is an increasing demand for a substrate transfer device to efficiently transfer a large-size substrate. In view of this, an attempt is made to increase the storage efficiency of a cassette by reducing the vertical spacing of rack pieces and eventually narrowing the pitch between substrates.

A large-size substrate is likely to suffer from warpage caused by its own weight. With a view to solve such a problem, there is disclosed a cassette (hereinafter referred to as “wire cassette”) in which wires are extended along the lower surface of a substrate at regular intervals in a direction orthogonal to the drawing-out direction of the substrate (see, e.g., Japanese Patent Application Publication No. 2005-145628 (JP2005-145628A)). The wire cassette is capable of efficiently storing even a large-size substrate with no likelihood of warpage.

### SUMMARY OF THE INVENTION

In accordance with an aspect of the present invention, there is provided a substrate transfer hand for unloading and loading a substrate with respect to a cassette and transferring the substrate. The substrate transfer hand includes: a first driven roller configured to be rotated by a drive mechanism provided in the cassette when the hand is coupled to the cassette along a substrate unloading/loading direction.

### BRIEF DESCRIPTION OF THE DRAWINGS

The objects and features of the present invention will become apparent from the following description of embodiments, given in conjunction with the accompanying drawings, in which:

FIG. 1A is a schematic view showing a substrate transfer system including a substrate transfer hand and a substrate transfer device in accordance with an embodiment of the present invention;

FIG. 1B is a view illustrating a substrate unloading/loading method performed by the substrate transfer hand in accordance with the present embodiment.

FIG. 2 is a view showing one configuration example of the substrate transfer hand;

FIG. 3A is a side view of the substrate transfer hand;

FIG. 3B is an enlarged view showing mechanical parts in which a first driven roller is driven by a drive mechanism;

FIG. 4 is a view showing how roller shafts are interconnected by belts;

FIG. 5 is a cross sectional view of a support bar taken along line V-V in FIG. 4;

FIG. 6 depicts an operation of releasing the coupling between the support bars and the cassette.

FIG. 7A is a view showing one example of a lock mechanism employing a lock plate;

FIG. 7B is a view showing one example of a lock mechanism employing an electromagnetic brake;

FIG. 7C is a view showing one example of a lock mechanism employing a belt fastening clasp;

FIG. 7D is a front view of the lock mechanism employing the belt fixing clasp;

FIG. 7E is a view showing one example of a lock mechanism employing a roller shaft with a taper portion;

FIG. 7F is an enlarged view showing the taper portion and its surroundings;

FIG. 7G is a view showing one example of a lock mechanism employing a pin cylinder;

FIG. 7H is a view showing one example of a lock mechanism employing a latch;

FIG. 7I is a view showing one example of a lock mechanism employing a neodymium magnet;

FIG. 8A is a schematic diagram showing the support bars each having a guide member, which is seen from the X-axis positive side; and

FIG. 8B is a schematic diagram showing the support bars each having a guide member, which is seen from the Z-axis positive side.

### DESCRIPTION OF THE EMBODIMENTS

A substrate transfer hand and a substrate transfer device including the substrate transfer hand, in accordance with one embodiment of the present invention, will now be described with reference to the accompanying drawings. The present invention is not limited to the embodiment.

In the following description, the substrate transfer hand will sometimes be called “hand”. Hereinafter, description will be made on a case where a typical wire cassette is used as the cassette. The wire cassette will sometimes be called “cassette”.

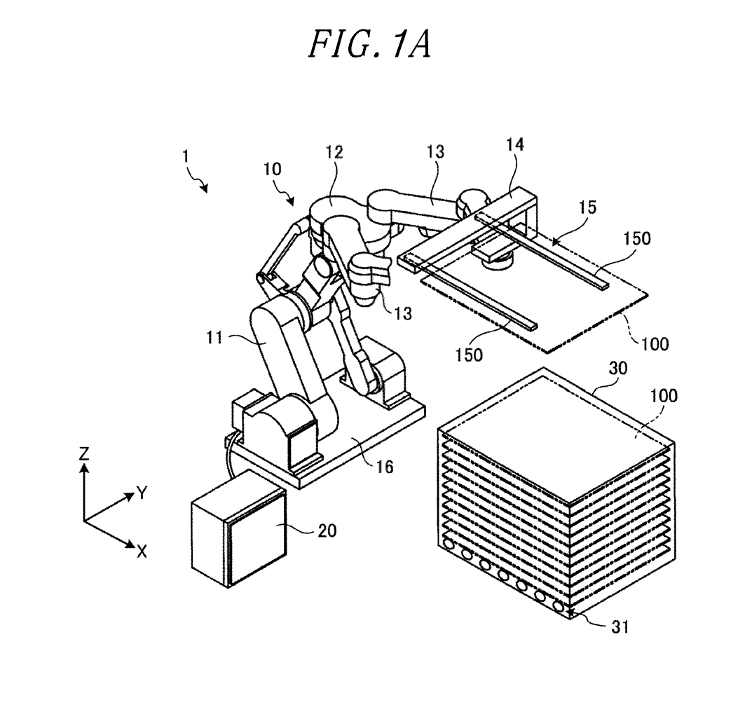

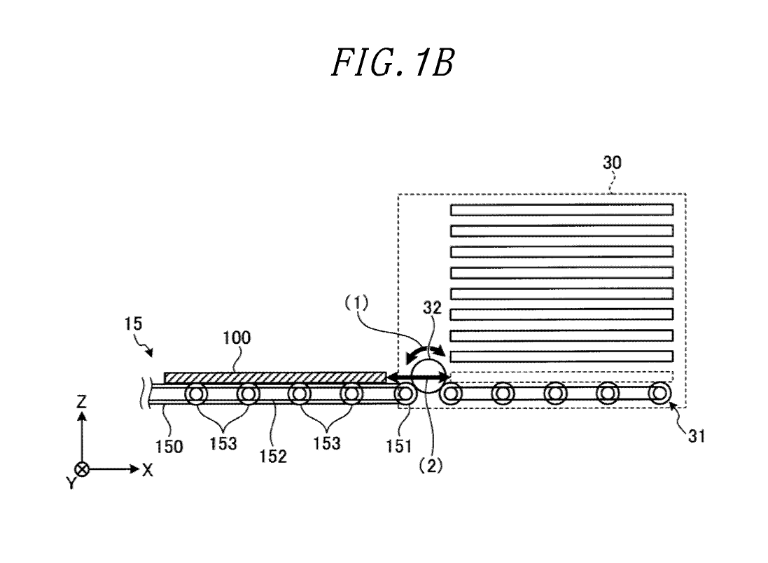

First, a substrate transfer system including a substrate transfer hand and a substrate transfer device in accordance with the present embodiment will be briefly described with reference to FIG. 1A. FIG. 1A is a schematic view showing a substrate transfer system 1 including a fork-shaped substrate transfer hand 15 and a substrate transfer device 10 in accordance with the present embodiment. For the sake of easier understanding, FIG. 1A shows a three-dimensional orthogonal coordinate system including a Z-axis whose positive side is the vertical upper side. This three-dimensional orthogonal coordinate system is often adopted in other views used in the following description.

In the following description, if there are components provided in pair, it is sometimes the case that only one of each part of the components will be designated by a reference symbol and the other will not be designated by a reference symbol. In this case, it is to be understood that the components making a pair have the same configuration.

Referring to FIG. 1A, the substrate transfer system 1 includes the substrate transfer device 10, a controller 20 and a cassette 30.

The substrate transfer device 10 serves to take out, one by one, substrates 100 accommodated within the cassette in multiple stages to transfer same. Now, description will be made on one configuration example of the substrate transfer device 10.

As shown in FIG. 1A, the substrate transfer device 10 includes an elevator mechanism 11, a swivel mechanism 12, an expansion and contraction mechanisms 13, a support member 14, the hand 15 and a base 16. The elevator mechanism 11 is supported on the base 16 fixed to a floor or the like. The elevator mechanism 11 serves to perform an operation of moving up and down along an XZ plane containing an X-axis and a Z-axis.

The swivel mechanism 12 is supported on the elevator mechanism 11 and swivels about a rotation axis parallel to the Z-axis. The expansion and contraction mechanism 13 is supported on the swivel mechanism 12 and expands and contracts along the XY plane. While a pair of expansion and contraction mechanisms 13 is shown in FIG. 1A, one of the expansion and contraction mechanisms 13 is partially removed for the sake of easier understanding of the drawing.

The substrate transfer device 10 includes a so-called articulated arm made up of the elevator mechanism 11, the swivel mechanism 12 and the expansion and contraction mechanism 13. Individual joints of the articulated arm are driven by servo motors (not shown). The controller 20 is a control unit for storing servo motor control programs and controlling the operation of the articulated arm pursuant to the control programs.

The hand 15 is attached to an end portion of the articulated arm through the support member 14.

The fork-shaped hand 15 includes a pair of plate-like support bars 150 for supporting one of the substrates 100 thereon. The support bars 150 are held by the support member 14 attached to an end portion of the expansion and contraction mechanism 13 (i.e., the end portion of the articulated arm).

The cassette 30 serves to accommodate the substrates 100 therein in multiple stages with major surfaces of the substrates 100 extending parallel to the XY plane. The cassette 30 includes a conveyor unit 31 provided in the lowermost stage. The conveyor unit 31 includes a drive mechanism 32 (not shown in FIG. 1A) and, by the operation of the drive mechanism 32, the substrates 100 can be unloaded from the cassette 30 one by one, starting from the lowermost one. The substrates 100 can be loaded into the cassette 30 one by one by operating the drive mechanism 32 in the opposite direction from the unloading direction.

Now, a substrate unloading/loading method performed by the hand 15 in accordance with the present embodiment will be described with reference to FIG. 1B. FIG. 1B is a view illustrating a substrate unloading/loading method performed by the hand 15 in accordance with the present embodiment. FIG. 1B schematically illustrates the support bars 150 and the cassette 30 as seen from the negative side in the Y-axis direction.

Referring to FIG. 1B, the hand 15 of the present embodiment includes a first driven roller 151 which is rotated by the drive mechanism 32 of the cassette 30 in a state that the hand 15 is coupled to the cassette 30 in the unloading/loading direction of the substrates 100. In the substrate unloading/loading method performed by the hand 15 in accordance with the present embodiment, the unloading/loading of the substrates 100 is carried out by the rotation of the first driven roller 151.

Specifically, as shown in FIG. 1B, the support bars 150 of the hand 15 of the present embodiment are coupled to a substrate unloading/loading port of the cassette 30 when the substrate 100 is unloaded or loaded. At this time, the first driven roller 151 is arranged in a specified position where the first driven roller 151 can be driven by the drive mechanism 32. In FIG. 1B, there is shown an example in which the first driven roller 151 is provided in a tip end portion of each of the support bars 150 and is driven by the drive mechanism 32 in the vicinity of the unloading/loading port of the cassette 30.

The support bars 150, while being coupled to the unloading/loading port of the cassette 30, are supported on the cassette 30 by a support structure or a support member (not shown) so that misalignment does not occur due to vibrations. The support of the support bars 150 can be performed by, e.g., inserting the support bars 150 into concave grooves previously formed in the cassette 30 so that the support bars 150 can be fitted thereto.

The hand 15 of the present embodiment includes a plurality of belts 152 serving as a rotation transmitting unit and a plurality of second driven rollers 153. The belts 152 transmit the rotation of the first driven roller 151 to the second driven rollers 153 along the support bars 150. The second driven rollers 153 are driven by the belts 152 and thus rotated in the same direction as the rotating direction of the first driven roller 151. The second driven rollers 153 are rotated while supporting one of the substrates 100 on the outer circumferential surfaces thereof, thereby transferring the substrate 100 along the support bars 150.

In response to the operation of the drive mechanism 32, i.e., the operation of the conveyor unit 31, indicated by reference symbol (1) in FIG. 1B, each of the substrates 100 can be unloaded from the cassette 30 and then mounted on the support bars 150 or, conversely, the substrate 100 mounted on the support bars 150 can be loaded into the cassette 30, as indicated by reference symbol (2) in FIG. 1B.

For example, if the drive mechanism 32 rotates clockwise when seen from the negative side in the Y-axis direction, the conveyor unit 31 unloads one of the substrates 100 to the negative side in the X-axis direction. Responsive to this operation, the hand 15 of the present embodiment can transfer the substrate 100 to the negative side in the X-axis direction and can bring the substrate 100 onto the support bars 150.

On the other hand, if the drive mechanism 32 rotates counterclockwise when seen from the negative side in the Y-axis direction, the hand 15 of the present embodiment transfers the substrate 100 mounted on the support bars 150 to the positive side in the X-axis direction. Responsive to this operation, the conveyor unit 31 can load the substrate 100 into the cassette 30 by moving the substrate 100 to the positive side in the X-axis direction.

The configuration of the cassette 30 for sequentially unloading the substrates 100 accommodated within the cassette 30 in multiple stages or sequentially loading the substrates 100 into the cassette 30 is well-known in the art (see JP2005-145628A) and, therefore, will not be described herein.

With the substrate unloading/loading method using the hand 15 of the present embodiment, the unloading/loading of the substrates 100 can be performed without having to put the support bars 150 into the cassette 30. It is therefore possible to safely and efficiently perform the unloading/loading works even if the pitch between the substrates 100 in the cassette 30 is narrow.

With the substrate unloading/loading method using the hand 15 of the present embodiment, the operation of the drive mechanism 32 provided in the cassette 30 can be utilized by the hand 15. This eliminates the need for the hand 15 to have its own drive mechanism. It is therefore possible to reduce the weight load applied to the articulated arm of the substrate transfer device 10 including the hand 15. This enables the substrate transfer device 10 to adapt itself to large-size substrates without hindrance.

While FIG. 1B illustrates a case where the rotation of the first driven roller 151 is transmitted to the second driven rollers 153 by use of the belts 152, the rotation transmitting method is not limited thereto. As an alternative example, the rotation may be transmitted only by the combination of roller members without having to use the belts 152.

While the belts 152 are exposed to the outside of the support bars 150 in FIG. 1B, the arrangement position of the belts 152 is not limited thereto. As an alternative example, the belts 152 may be arranged within the support bars 150. In this regard, the following description will be made under the assumption that the belts 152 are arranged within the support bars 150.

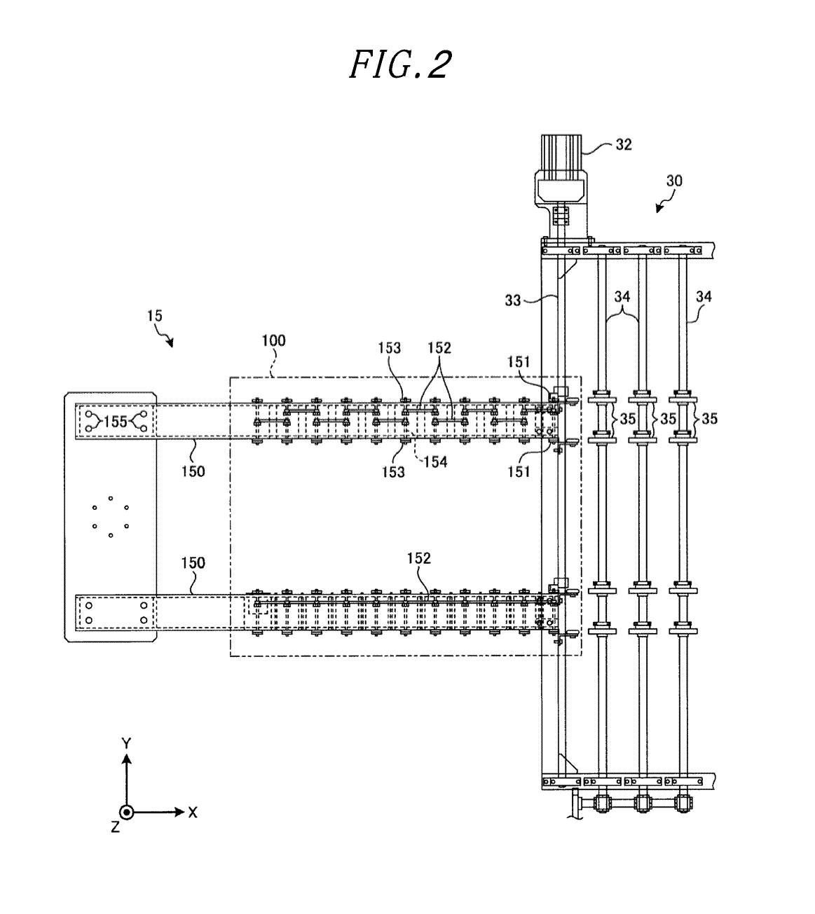

Next, one configuration example of the hand 15 in accordance with the present embodiment will be described with reference to FIG. 2. FIG. 2 is a view showing one configuration example of the hand 15 of the present embodiment. FIG. 2 is a plan view of the hand 15 seen from the positive side in the Z-axis direction.

In FIG. 2, the respective members of the support bar 150 positioned at the upper side are primarily designated by reference symbols. Since the support bar 150 positioned at the lower side has substantially the same configuration as that of the support bar 150 positioned at the upper side, reference symbols are given to only some of the members of the support bar 150 positioned at the lower side.

Referring to FIG. 2, the hand 15 includes a pair of support bars 150. One end portions of the support bars 150 are coupled to the cassette 30 in the unloading/loading direction of the substrates 100 (in the X-axis positive and negative direction in FIG. 2). The support bars 150 are members for holding the substrate 100 when unloading/loading and transferring the substrate 100. A carbon-fiber-reinforced plastic can be used as the material of the support bars 150.

The other end portions of the support bars 150 opposite from the cassette 30 are fixed to the support member 14 attached to the end portion of the articulated arm. No particular limitation is imposed on how to fix the support bars 150 to the support member 14. For instance, as shown in FIG. 2, the support bars 150 can be fixed to the support member 14 by forming tap holes 155 in the support bars 150 and driving bolts into the tap holes 155.

Each of the support bars 150 includes a plurality of roller shafts 154 arranged within the support bars 150. The roller shafts 154 are rotating shaft members extending through the support bars 150 in the direction parallel to the major surfaces of the support bars 150 and orthogonal to the unloading/loading direction of the substrates 100 (in the Y-axis positive and negative direction in FIG. 2). The roller shafts 154 are rotatably supported by bearings (not shown) provided in the positions where the roller shafts 154 intersect the outer shells of the support bars 150. The roller shafts 154 are arranged side by side at a specified interval.

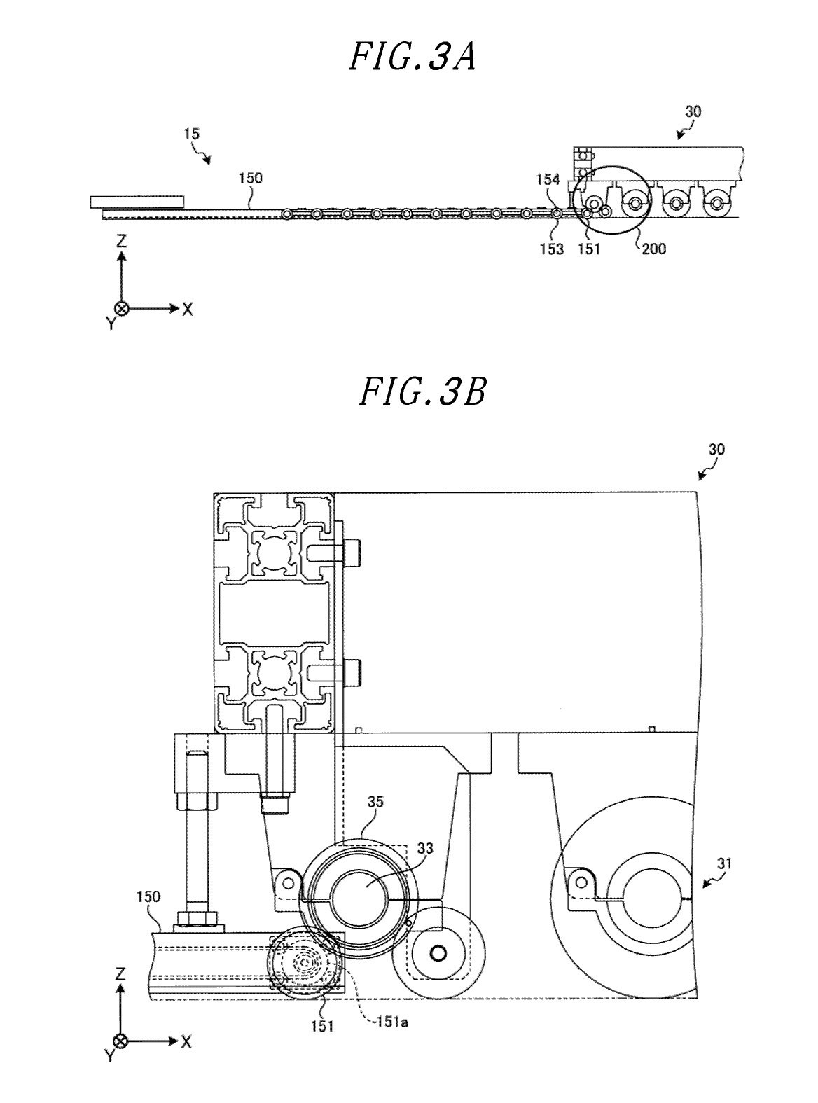

The first driven roller 151 or the second driven roller 153 is attached to the opposite ends of the corresponding roller shaft 154 protruding from the side surfaces of the support bars 150. The first driven roller 151 is a roller member rotated by the drive mechanism 32 of the cassette 30 in the position where the hand 15 is coupled to the cassette 30. The details of the first driven roller 151 will be described later with reference to FIG. 3B,

The second driven rollers 153 are roller members other than the first driven roller 151, which are arranged side by side along the support bars 150. All the second driven rollers 153 are rotated in the same direction in response to the rotation of the first driven roller 151.

In FIG. 2, some of the second driven rollers 153 and the roller shafts 154 are designated by reference symbols and the others are not designated by reference symbols. This holds true in other views to be described below.

In this regard, the rotation of the first driven roller 151 is transmitted by the belts 152. The belts 152 are members for operatively interconnecting the roller shafts 154 arranged side by side within the support bars 150.

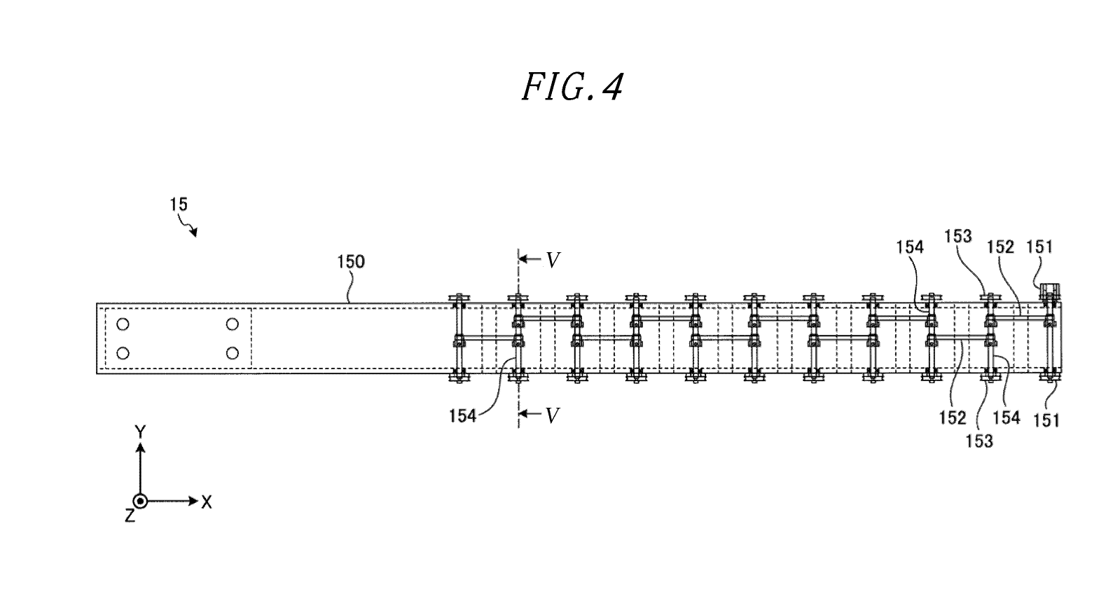

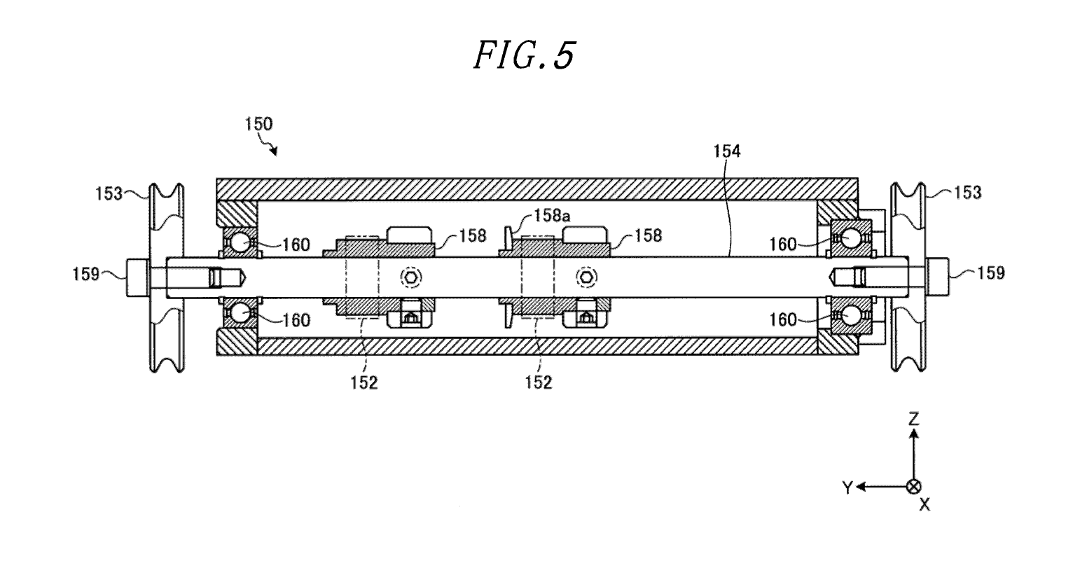

No particular limitation is imposed on how to interconnect the roller shafts 154 by the belts 152. For example, each of the belts 152 may be stretched over the adjoining roller shafts 154 (see the upper support bar 150 in FIG. 2). Alternatively, a single continuously-extending belt 152 may be stretched over all the roller shafts 154 (see the lower support bar 150 in FIG. 2). On the example in which each of the belts 152 is stretched over the adjoining roller shafts 154, description will be made later with reference to FIGS. 4 and 5.

The internal mechanism of the cassette 30 will now be described with reference to FIG. 2. As shown in FIG. 2, the cassette 30 includes the drive mechanism 32, a drive shaft 33, a plurality of roller shafts 34 and a plurality of rollers 35.

The drive mechanism 32 serves to rotate the drive shaft 33 about a rotation axis extending in the Y-axis direction. The drive mechanism 32 may be formed of a geared motor or the like. The drive shaft 33 is a rotating shaft member extending through the cassette 30 in the Y-axis direction. The drive shaft 33 is rotatably supported by bearings (not shown) provided in the position where the drive shaft 33 intersects the outer shell of the cassette 30.

The drive shaft 33 is connected at one end to the drive mechanism 32 and is directly rotated by the drive mechanism 32.

The roller shafts 34 are rotating shaft members extending through the cassette 30 in the Y-axis direction just like the drive shaft 33. The roller shafts 34 are rotatably supported by bearings (not shown) provided in the positions where the roller shafts 34 intersect the outer shell of the cassette 30. The roller shafts 34 are arranged side by side at a specified interval.

All the roller shafts 34 are rotated in the same direction in response to the rotation of the drive shaft 33. No particular limitation is imposed on how to interlock the drive shaft 33 and the roller shafts 34.

The rollers 35 are roller members provided in the intermediate extensions of the drive shaft 33 and the roller shafts 34. The rollers 35 are rotated in the same direction while supporting one of the substrates 100 on the outer circumferential surfaces thereof, thereby unloading or loading each of the substrates 100 along the X-axis.

In the hand 15 of the present embodiment, the rotation of the drive shaft 33 caused by the operation of the drive mechanism 32 of the cassette 30 is transmitted to the first driven roller 151. In this regard, description will be made later with reference to FIG. 3B.

Now, description will be made on the hand 15 seen from one side thereof. FIG. 3A is a side view of the hand 15 of the present embodiment, which is seen from the negative side in the Y-axis direction.

As shown in FIG. 3A, the first driven roller 151 and the second driven rollers 153 are attached to the support bars 150 so that the outer circumferences thereof can protrude slightly upward beyond the upper surface of the support bars 150 when seen from the negative side in the Y-axis direction. Such attachment can be performed by, e.g., using the first driven roller 151 and the second driven rollers 153, both of which have a diameter slightly larger than the thickness of the support bars 150. It is preferred that the first driven roller 151 and the second driven rollers 153 have the same diameter.

Accordingly, each of the substrates 100 is placed on the outer circumferential surfaces of the first driven roller 151 and the second driven rollers 153 and is unloaded or loaded along the X-axis. If the support bars 150 have a specified thickness and if the first driven roller 151 and the second driven rollers 153 have a diameter smaller than the thickness of the support bars 150, it is desirable that the first driven roller 151 and the second driven rollers 153 be fitted to the roller shafts 154 in such positions where the outer circumferences of the first driven roller 151 and the second driven rollers 153 protrude slightly upward beyond the upper surfaces of the support bars 150.

The portion surrounded by a circle 200 in FIG. 3A indicates the mechanical parts in which first driven roller 151 is driven by the drive mechanism 32 of the cassette 30. Next, description will be made on such mechanical parts.

FIG. 3B is an enlarged view showing the mechanical parts in which the first driven roller 151 is driven by the drive mechanism 32. As shown in FIG. 3B, when the support bars 150 are coupled to the cassette 30, the first driven roller 151 makes contact with the roller 35 attached to the drive shaft 33.

The types of such contact do not matter as long as the rotation of the drive shaft 33 can be transmitted to the first driven roller 151. For instance, FIG. 3B illustrates an example in which the outer circumference of the roller 35 makes contact with an inner diameter portion 151a of the first driven roller 151.

The outer circumference of the roller 35 and the inner diameter portion 151a of the first driven roller 151 may be formed into, e.g., a gear shape. In this case, the outer circumference of the roller 35 and the inner diameter portion 151a of the first driven roller 151 mesh with each other, whereby the first driven roller 151 is rotated by the rotation of the drive shaft 33.

If the gear meshing configuration is employed in this manner, it is possible to obtain an advantage in that the first driven roller 151 can be reliably driven by the drive mechanism 32.

In the example shown in FIG. 3B, the rotating direction of the drive shaft 33 and the rotating direction of the first driven roller 151 are opposite to each other. In other words, if the drive shaft 33 rotates clockwise when seen from the negative side in the Y-axis direction, the first driven roller 151 is rotated counterclockwise, i.e., in the direction in which the substrate 100 is unloaded toward the negative side in the X-axis direction.

On the other hand, if the drive shaft 33 rotates counterclockwise when seen from the negative side in the Y-axis direction, the first driven roller 151 is rotated clockwise, i.e., in the direction in which the substrate 100 is loaded toward the positive side in the X-axis direction. Since the rotating direction of the first driven roller 151 is required to coincide with the substrate conveying direction of the conveyor unit 31 of the cassette 30, it is of paramount importance that the roller 35 and the first driven roller 151 be combined to satisfy such requirement.

While the foregoing description is directed to a case where the first driven roller 151 and the roller 35 make contact with each other, the rotation of the drive mechanism 32 may be transmitted to the first driven roller 151 without having to bring the first driven roller 151 and the roller 35 into contact with each other.

The contactless transmission of rotation can be realized through the use of a magnetic gear or the like. In this case, the first driven roller 151 can be rotated by a magnetic action. This makes it possible to prevent wear or degradation of parts which may otherwise be caused by the contact of parts. It is also possible to prevent, e.g., dispersion of dust which may otherwise be caused by the contact of parts. Thus, the contactless transmission of rotation is particularly useful in case where the substrates 100 are glass substrates such as liquid crystal panels which tend to be adversely affected by dust.

While the foregoing description is directed to a case where the drive mechanism 32 is arranged within the cassette 30, such description is not intended to particularly limit the arrangement position of the drive mechanism 32. In case where the drive mechanism 32 is arranged outside the cassette 30, the rotation of the drive mechanism 32 may be transmitted to the first driven roller 151 through, e.g., the combination of gears or the use of a belt and a pulley.

Next, a method of interconnecting the roller shafts 154 by use of the belts 152 in order to transmit the rotation of the first driven roller 151 along the support bars 150 will be described with reference to FIG. 4. FIG. 4 is a view showing how the roller shafts 154 are interconnected by the belts 152. In FIG. 4, the upper one of the support bars 150 shown in FIG. 2 is shown on an enlarged scale.

In the hand 15 of the present embodiment, as shown in FIG. 4, the roller shafts 154 are interconnected by sequentially and independently stretching the belts 152 over the respective pairs of the adjoining roller shafts 154. This makes it possible to transmit the rotation of the first driven roller 151 along the support bars 150 in the X-axis positive and negative direction.

If the belts 152 are stretched over the respective pairs of the adjoining roller shafts 154 in this manner, it is possible to make sure that the looseness of each of the belts 152 caused by the degradation thereof affects only one pair of the adjoining roller shafts 154.

In this case, as shown in FIG. 4, the tensions of the belts 152 stretched over the roller shafts 154 having the second driven rollers 153 attached thereto are distributed to two points. It is therefore possible to restrain imbalance of the forces applied to the roller shafts 154 and to transmit the rotation with no imbalance.

One of the roller shafts 154 will now be further described with reference to FIG. 5. FIG. 5 is a cross sectional view of the support bar 150 taken along line V-V in FIG. 4.

As shown in FIG. 5, the roller shaft 154 extends in the Y-axis direction through the outer shell of the support bar 150 formed of an upper member, a lower member and a pair of side members. The roller shaft 154 is rotatably supported by bearings 160.

As described earlier, the second driven rollers 153 are attached to the opposite end portions of the roller shaft 154 protruding from the outer shell of the support bar 150. Locking pins 159 or bolts can be used in attaching the second driven rollers 153.

A plurality of pulleys 158 is attached to the intermediate extension of the roller shaft 154. While FIG. 5 shows an example in which two pulleys 158 are attached to the roller shaft 154, the number of the pulleys 158 is not limited thereto but may be equal to the number of connecting points.

The belts 152 can be stretched over the pulleys 158. Each of the pulleys 158 may include a guide 158a for preventing transverse movement of each of the belts 152.

Inasmuch as the mechanism for transmitting the rotation of the first driven roller 151 is provided within the support bar 150 as set forth above, it is possible to prevent dispersion of dust generated by the contact of parts. This makes it possible to transfer a glass substrate, such as a liquid crystal panel or the like, with no adhesion of dust while maintaining the quality thereof.

In case where the substrate 100 is unloaded from the cassette 30, it is preferred that the coupling between the support bars 150 of the hand 15 and the cassette 30 is released if the substrate 100 reaches a specified position on the support bars 150.

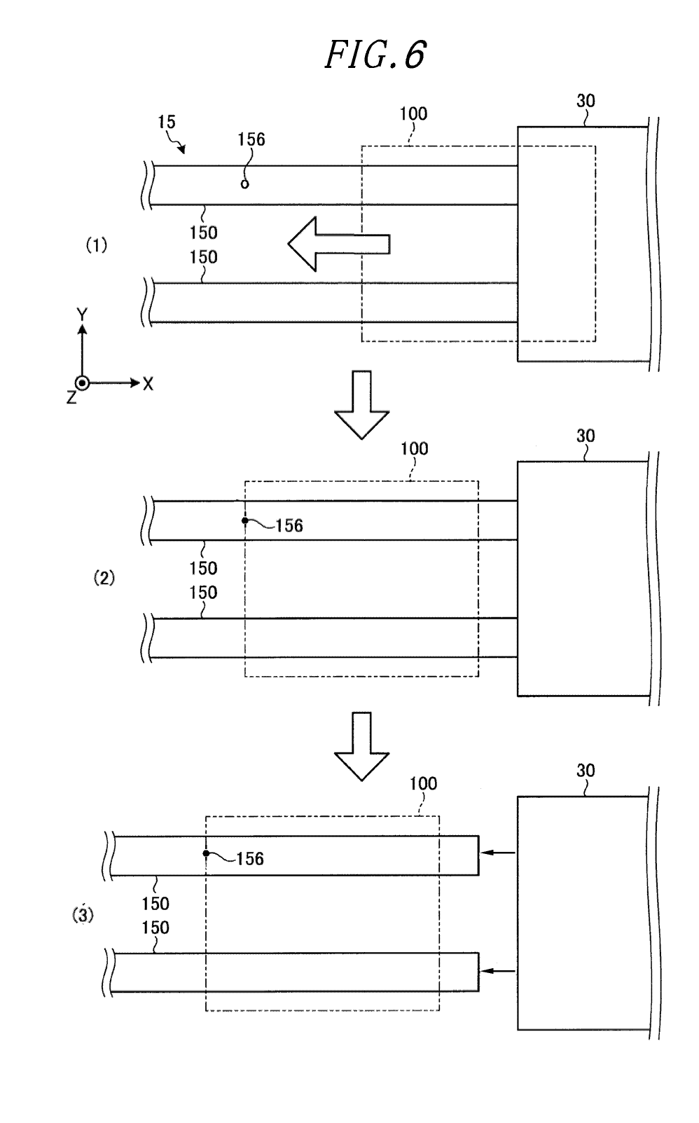

In this regard, description will be made with reference to FIG. 6. FIG. 6 depicts an operation of releasing the coupling between the support bars and the cassette. FIG. 6 is schematic illustration as seen from the positive side in the Z-axis direction.

As shown in FIG. 6, the hand 15 of the present embodiment includes a sensor 156 for detecting the arrival of the unloaded substrate 100 at a specified position on the support bars 150. In FIG. 6, there is illustrated an example in which the sensor 156 is provided in at least one of the support bars 150.

As illustrated in FIG. 6(1), the substrate 100 is unloaded toward the negative side in the X-axis direction. At this time, the sensor 156 remains inactive unless it detects one end of the substrate 100. This state of the sensor 156 is indicated by symbol “∘” in FIG. 6(1).

If one end of the substrate 100 reaches the installation position of the sensor 156, the sensor 156 detects that the substrate 100 is unloaded by a specified amount (see symbol “•” in FIG. 6(2)). Then, the sensor 156 notifies the controller 20 (see FIG. 1A) of such detection.

Upon receiving the notice, the controller 20 controls the articulated arm so as to release the coupling between the support bars 150 and the cassette 30 as shown in FIG. 6(3). By releasing the coupling when the substrate 100 is unloaded by the specified amount, it is possible to prevent the substrate 100 from being excessively unloaded and to smoothly transfer the substrate 100 to a substrate processing unit.

While the description made with reference to FIG. 6 is directed to a case where the unloading amount of the substrate 100 is detected by the sensor 156, such description is not intended to particularly limit the method of detecting the unloading amount of the substrate 100. As an alternative example, the unloading amount of the substrate 100 may be determined pursuant to, e.g., the rotation angle of the first driven roller 151.

In order to reliably prevent excessive unloading of the substrate 100 when releasing the coupling between the support bars 150 and the cassette 30 as shown in FIG. 6(3), it is preferred that at least one of the first driven roller 151, the belts 152 and the second driven rollers 153 be locked so that the rotation should not be transmitted along the support bars 150 any longer.

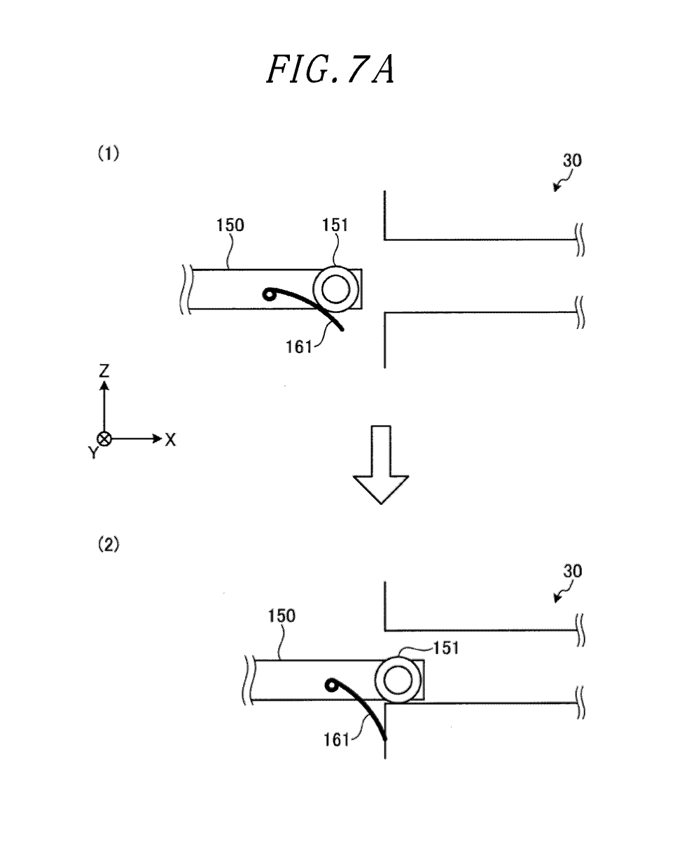

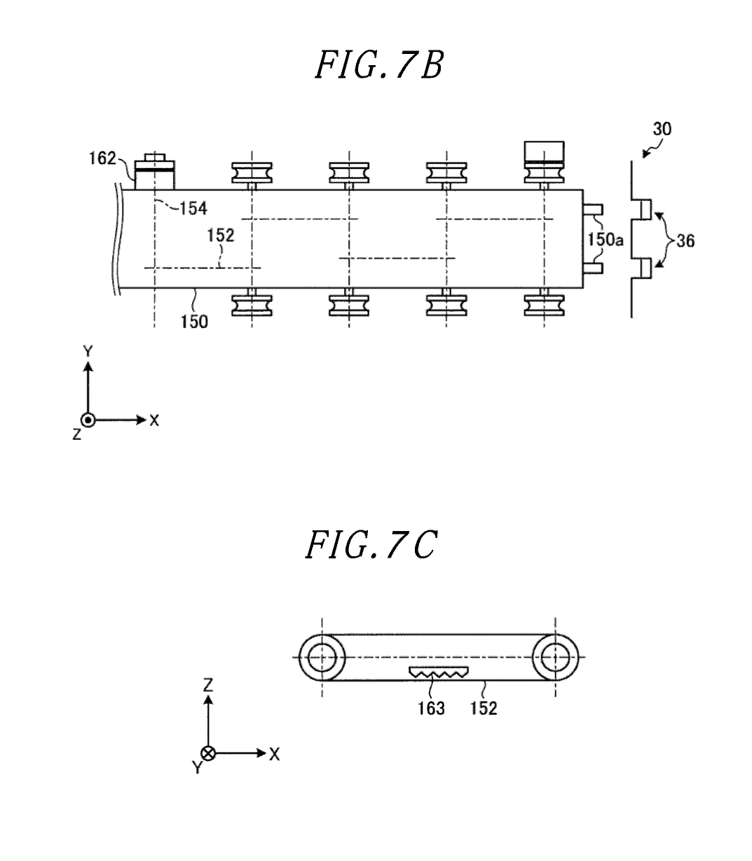

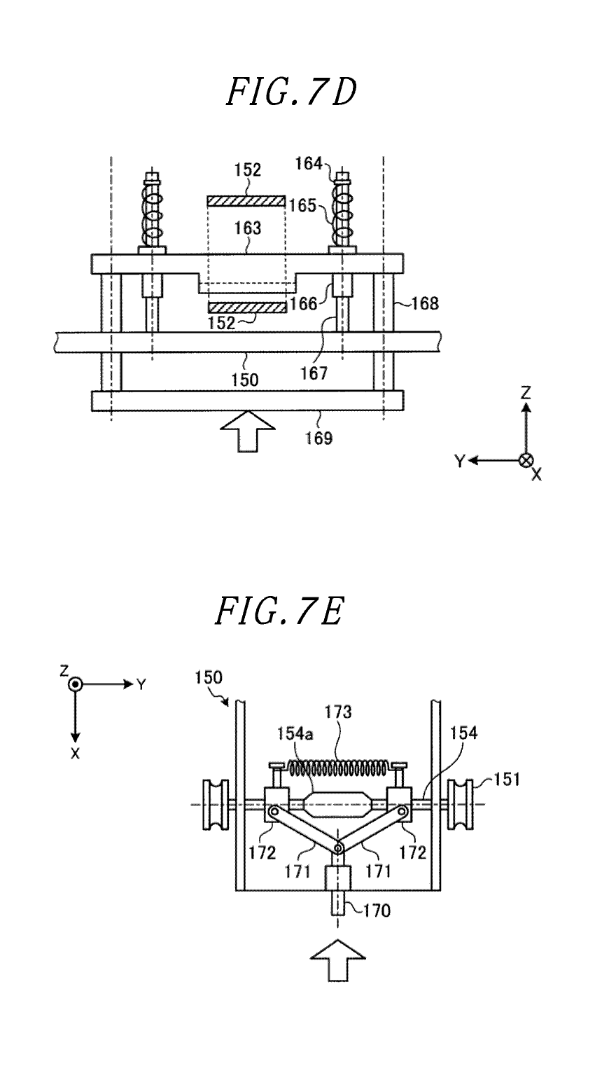

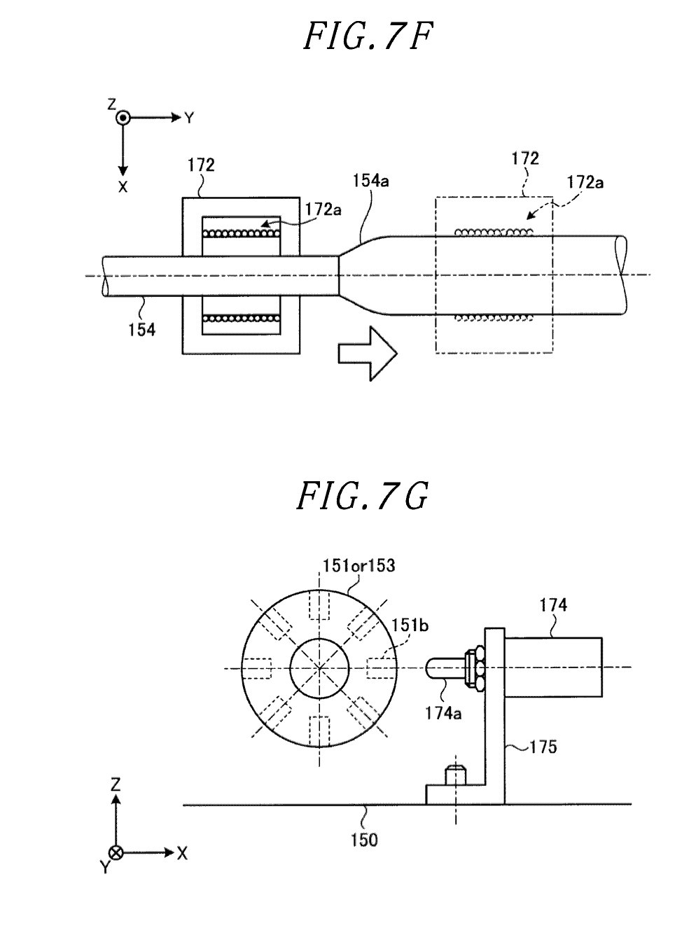

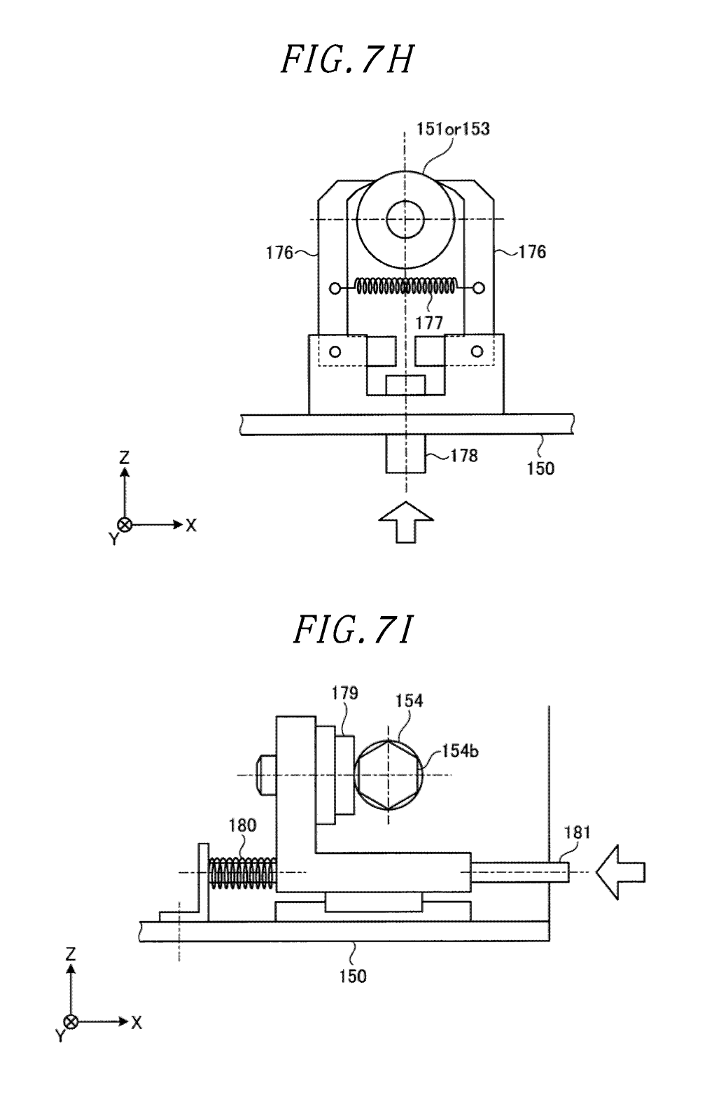

Certain configuration examples of a lock mechanism for realizing such a locking function will now be described with reference to FIGS. 7A through 7I. First, description will be made on a configuration example of a lock mechanism employing a lock plate. FIG. 7A is a view showing one example of a lock mechanism employing a lock plate 161. FIG. 7A is a schematic illustration as seen from the negative side in the Y-axis direction.

Referring to FIG. 7A(1), the support bar 150 includes, as a lock mechanism, the lock plate 161 arranged near the first driven roller 151.

The lock plate 161 is a member formed of an elastic material such as a leaf spring or the like. If the support bars 150 are kept disconnected from the cassette 30 as illustrated in FIG. 7A(1), the lock plate 161 resiliently presses against the outer circumferential surface of the first driven roller 151, thereby locking the first driven roller 151 against rotation.

On the other hand, if the support bars 150 are coupled to the cassette 30 as illustrated in FIG. 7A(2), the end portion of the lock plate 161 makes contact with the surface of the outer shell of the cassette 30. In other words, the lock plate 161 presses against the surface of the outer shell of the cassette 30 instead of the outer circumferential surface of the first driven roller 151.

As a result, the first driven roller 151 is released from the resilient biasing force of the lock plate 161 and is rendered rotatable.

If the coupling between the support bars 150 and the cassette 30 is released again, the lock plate 161 resiliently presses against the outer circumferential surface of the first driven roller 151, thereby locking the first driven roller 151 against rotation (see FIG. 7A(1)).

By releasing the first driven roller 151 to freely rotate when the support bars 150 and the cassette 30 are coupled to each other and locking the first driven roller 151 against rotation when the coupling between the support bars 150 and the cassette 30 is released, it is possible to reliably prevent unnecessary displacement of the substrate 100 during transfer of the substrate 100.

Since the lock plate 161 is a lock mechanism attached to only the support bar 150, it is possible to obtain an advantage in that there is no need to add a new member to the cassette 30.

Next, description will be made on a configuration example of a lock mechanism employing an electromagnetic brake. FIG. 7B is a view showing one example of a lock mechanism employing an electromagnetic brake 162. FIG. 7B is a plan view seen from the positive side in the Z-axis direction.

Referring to FIG. 7B, the support bar 150 includes, as a lock mechanism, the electromagnetic brake 162. The electromagnetic brake 162 is a so-called power-off activated brake that generates a braking force when the coil thereof is de-energized. The electromagnetic brake 162 is attached to one of the roller shafts 154.

The electromagnetic brake 162 is designed to remove the braking force when the coil thereof is energized. The energization is performed through the use of probes 150a provided in the tip end portion of the support bar 150 and connected to the electromagnetic brake 162 by using connecting cables. The probes 150a are combined with a receptacle (not shown) so that they can be replaced with ease.

Specifically, power supply lines are established and energization is performed upon inserting the probes 150a into power supply units 36 provided in the cassette 30 in advance. In other words, as the support bar 150 is coupled to the cassette 30 by the insertion of the probes 150a, the electromagnetic brake 162 removes the braking force and makes the respective rollers rotatable.

By using the electromagnetic brake 162 in this manner, the respective rollers are released to freely rotate when the support bars 150 and the cassette 30 are coupled to each other. The respective rollers are locked against rotation when the coupling between the support bars 150 and the cassette 30 is released. This makes it possible to reliably prevent unnecessary displacement of the substrate 100 during transfer of the substrate 100.

In addition, as shown in FIG. 7B, the power is supplied from the cassette 30 to the support bar 150. All that are needed in the hand 15 is to arrange the connecting cables. It is therefore possible to reduce the weight load applied to the hand 15 by the component parts.

If there exists a difficulty in providing the power supply units 36 in the cassette 30, the electric power may be supplied from the hand 15. In this case, a switch to be turned on by the contact of the support bars 150 with the cassette 30 may be used to establish power supply lines when the support bars 150 and the cassette 30 are coupled to each other and not to establish the power supply lines when the support bars 150 and the cassette 30 are disconnected from each other.

The electromagnetic brake 162 may be a power-on activated brake. In this case, as opposed to the power-off activated brake, the power supply lines are not established when the support bars 150 and the cassette 30 are coupled to each other and the power supply lines are established when the support bars 150 and the cassette 30 are disconnected from each other.

Next, description will be made on a configuration example of a lock mechanism employing a belt fastening clasp. FIG. 7C is a view showing one example of a lock mechanism employing a belt fastening clasp 163. FIG. 7C is a schematic illustration as seen from the negative side (or the positive side) in the Y-axis direction.

As shown in FIG. 7C, the support bar 150 includes, as a lock mechanism, the belt fastening clasp 163. The belt fastening clasp 163 serves to engage with a toothed surface (not shown) of the belt 152. The belt fastening clasp 163, when moved toward the negative side in the Z-axis direction, engages with the belt 152 to thereby hold the belt 152 against movement. The belt fastening clasp 163, when moved toward the positive side in the Z-axis direction, releases the belt 152 so that the belt 152 can transmit the rotation.

One configuration example of the lock mechanism employing the belt fastening clasp 163 will now be described in detail. FIG. 7D is a front view showing the lock mechanism employing the belt fastening clasp 163. FIG. 7D is an illustration as seen from the negative side (or the positive side) in the X-axis direction.

As illustrated in FIG. 7D, the lock mechanism includes the belt fastening clasp 163, a pair of slide bushes 166, a pair of linear shafts 167, a pair of support portions 168 and a pressing portion 169.

The slide bushes 166 are linear motion bearings for allowing the linear shafts 167 to move in the Z-axis direction. The slide bushes 166 may be oilless bearings. The linear shafts 167 extend through the belt fastening clasp 163 with the slide bushes 166 interposed between the linear shafts 167 and the belt fastening clasp 163. The linear shafts 167 are fixed to the bottom plate of the support bar 150.

Retaining rings 164 are attached to the free ends of the linear shafts 167. Compression springs 165 are arranged between the retaining rings 164 and the slide bushes 166. The pressing portion 169 is arranged outside the bottom plate of the support bar 150 and is connected to the belt fastening clasp 163 by way of the support portions 168 extending through the bottom plate of the support bar 150.

When the support bars 150 and the cassette 30 are disconnected from each other, the biasing force acting toward the positive side in the Z-axis direction as indicated by an arrow in FIG. 7D is not applied to the pressing portion 169. In this case, the belt fastening clasp 163 is pressed against the belt 152 by the restoring forces of the compression springs 165 acing toward the negative side in the Z-axis direction. Thus, the belt fastening clasp 163 engages with the toothed surface of the belt 152, thereby locking the belt 152 against movement.

If the pressing portion 169 is pressed by the biasing force acting in the direction indicated by the arrow in FIG. 7D, the belt fastening clasp 163 is pushed up along the linear shafts 167 toward the positive side in the Z-axis direction and is disengaged from the belt 152. In other words, the belt fastening clasp 163 releases the belt 152 from the locked state so that the belt 152 can transmit the rotation.

When coupling the support bars 150 and the cassette 30 together, the substrate transfer device 10 controls the movement of the support bars 150 so that the pressing portion 169 is pressed. For example, the support bars 150 are moved toward the positive side in the X-axis direction and are slightly inserted into the unloading/loading port of the cassette 30. Thereafter, the support bars 150 are moved toward the negative side in the Z-axis direction to press the pressing portion 169 against the unloading/loading port of the cassette 30.

By using the belt fastening clasp 163 in this manner, the belt 152 is released to freely move when the support bars 150 and the cassette 30 are coupled to each other and the belt 152 is locked against rotation when the coupling between the support bars 150 and the cassette 30 is released. This makes it possible to reliably prevent unnecessary displacement of the substrate 100 during transfer of the substrate 100.

Next, description will be made on a configuration example of a lock mechanism employing a roller shaft with a taper portion. FIG. 7E is a view showing one example of a lock mechanism employing a roller shaft 154 with a taper portion 154a. FIG. 7E illustrates the tip end portion of the support bar 150 seen from the positive side in the Z-axis direction.

As illustrated in FIG. 7E, the lock mechanism includes the roller shaft 154, a pressing portion 170, a pair of movable bars 171, a pair of slide bushes 172 and a tension spring 173.

The roller shaft 154 is formed through a heat treatment process or other processes to have a thick shaft portion and thin shaft portions, the thick shaft portion and each of the thin shaft portions being connected by the taper portion 154a.

Each of the slide bushes 172 has a through-hole through which the roller shaft 154 extends. The through-hole has a diameter circumscribing the thick shaft portion.

The movable bars 171 and the pressing portion 170 are formed into a Y-like shape. The movable bars 171 are movably combined with each other and are connected to the slide bushes 172. A tension spring 173 is stretched between the slide bushes 172.

Now, the roller shaft 154 and the slide bushes 172 will be described in more detail. FIG. 7F is an enlarged view showing the taper portion 154a and its surroundings. As indicated by solid lines in FIG. 7F, the slide bush 172 positioned around the thin shaft portion of the roller shaft 154 does not make contact with the roller shaft 154 through the bearing 172a. At this time, the roller shaft 154 can freely rotate about the axis thereof.

In contrast, as indicated by a double-dot chain line in FIG. 7F, the slide bush 172 positioned around the thick shaft portion of the roller shaft 154 makes contact with the roller shaft 154 through the bearing 172a. At this time, it is possible to restrain the roller shaft 154 from rotating about the axis thereof.

If the pressing portion 170 is pressed toward the negative side in the X-axis direction as indicated by an arrow in FIG. 7E, the movable bars 171 are spread apart to move the slide bushes 172 to the thin shaft portions of the roller shaft 154, thereby releasing the roller shaft 154 to freely rotate.

On the other hand, if the pressing portion 170 is not pressed, the movable bars 171 are closed together by the tension of the tension spring 173 to move the slide bushes 172 to the thick shaft portion of the roller shaft 154, thereby locking the roller shaft 154 against rotation.

Accordingly, when the support bars 150 and the cassette 30 are coupled to each other, the substrate transfer device 10 controls the movement of the support bars 150 so as to press the pressing portion 170. This makes it possible to release the locking of the roller shaft 154 and the first driven roller 151 attached thereto. When the support bars 150 and the cassette 30 are disconnected from each other, the roller shaft 154 and the first driven roller 151 can be locked by the tension of the tension spring 173.

In order for the movable bars 171 to be reliably opened upon pressing the pressing portion 170, it is preferred that the movable bars 171 make an internal angle of 90 degrees or more when locking the roller shaft 154 and the first driven roller 151.

By using the roller shaft 154 having the taper portion 154a in this manner, the first driven roller 151 and the roller shaft 154 are released to freely rotate when the support bars 150 and the cassette 30 are coupled to each other. The first driven roller 151 and the roller shaft 154 are locked against rotation when the coupling between the support bars 150 and the cassette 30 is released. This makes it possible to reliably prevent unnecessary displacement of the substrate 100 during transfer of the substrate 100.

While the description made with reference to FIG. 7E is directed to a case where the pressing portion 170 is pressed toward the negative side in the X-axis direction, the pressing portion 170 may be pressed toward the positive side in the Z-axis direction as illustrated in FIG. 7D. In other words, the pressing portion 170 may be pressed from the lower side of the bottom plate of the support bar 150. In this case, FIG. 7E and FIG. 7F may be regarded as being seen from the positive side or the negative side in the X-axis direction.

Next, description will be made on a configuration example of a lock mechanism employing a pin cylinder. FIG. 7G is a view showing one example of a lock mechanism employing a pin cylinder 174. FIG. 7G is an illustration as seen from the negative side (or the positive side) in the Y-axis direction.

Referring to FIG. 7G, the lock mechanism includes the pin cylinder 174, a first driven roller 151 or a second driven roller 153 having a plurality of locking holes 151b on the outer circumferential surface thereof and a support portion 175 for supporting the pin cylinder 174. The pin cylinder 174 is driven by an air pressure or an electric power to extend or retract a pin 174a installed therein in the X-axis direction.

In the lock mechanism employing the pin cylinder 174, the first driven roller 151 or the second driven roller 153 is locked against rotation by extending the pin 174a to be fitted into one of the locking holes 151b. The locking is released by removing the pin 174a from the locking hole 151b.

Accordingly, the pin cylinder 174 is controlled to retract the pin 174a when the support bars 150 and the cassette 30 are coupled to each other. The pin cylinder 174 is controlled to extend the pin 174a when the support bars 150 and the cassette 30 are disconnected from each other. Just like the example shown in FIG. 7B, the supply source of an air pressure or an electric power may be provided in either the cassette 30 or the hand 15.

By using the pin cylinder 174 in this manner, the first driven roller 151 or the second driven roller 153 is released to freely rotate when the support bars 150 and the cassette 30 are coupled to each other. The first driven roller 151 or the second driven roller 153 is locked against rotation when the coupling between the support bars 150 and the cassette 30 is released. This makes it possible to reliably prevent unnecessary displacement of the substrate 100 during transfer of the substrate 100.

Next, description will be made on a configuration example of a lock mechanism employing a latch. FIG. 7H is a view showing one example of a lock mechanism employing latches 176. FIG. 7H is an illustration as seen from the negative side (or the positive side) in the Y-axis direction.

Referring to FIG. 7H, the lock mechanism includes a pair of latches 176, a tension spring 177 stretched between the latches 176 and a pressing portion 178.

If the pressing portion 178 is not pressed, the latches 176 grip the first driven roller 151 or the second driven roller 153 therebetween under the tension of the tension spring 177, thereby locking the first driven roller 151 or the second driven roller 153 against rotation.

On the other hand, if the pressing portion 178 is pressed in the direction indicated by an arrow in FIG. 7H, the latches 176 are opened through the contact with the pressing portion 178. Thus, the gripping is released, consequently allowing the first driven roller 151 or the second driven roller 153 to freely rotate.

In other words, when the support bars 150 and the cassette 30 are coupled to each other, the substrate transfer device 10 controls the movement of the support bars 150 so as to press the pressing portion 178 in the same manner as illustrated in FIG. 7D, thereby releasing the locking of the first driven roller 151 or the second driven roller 153.

By using the latches 176 in this manner, the first driven roller 151 or the second driven roller 153 is released to freely rotate when the support bars 150 and the cassette 30 are coupled to each other. The first driven roller 151 or the second driven roller 153 is locked against rotation when the coupling between the support bars 150 and the cassette 30 is released. This makes it possible to reliably prevent unnecessary displacement of the substrate 100 during transfer of the substrate 100.

In an effort to enhance the locking reliability in the example note just above, the outer circumferential surface of the first driven roller 151 or the second driven roller 153 may be machined into a spur gear shape. The latches 176 may grip therebetween the roller shaft 154 having an outer circumferential surface machined into a spur gear shape, instead of the first driven roller 151 or the second driven roller 153.

Next, description will be made on a configuration example of a lock mechanism employing a neodymium magnet. FIG. 7I is a view showing one example of a lock mechanism employing a neodymium magnet 179. FIG. 7I is an illustration as seen from the negative side in the Y-axis direction.

Referring to FIG. 7I, the lock mechanism includes the neodymium magnet 179, a compression spring 180 for biasing the support portion of the neodymium magnet 179 toward the positive side in the X-axis direction by the restoring force thereof and a pressing portion 181.

The roller shaft 154 includes a hexagonal portion 154b having a hexagonal cross section taken along the XZ plane.

When the support bars 150 and the cassette 30 are disconnected from each other, the neodymium magnet 179 and the hexagonal portion 154b (i.e., the roller shaft 154) are attracted toward each other under the magnetic action, thereby locking the roller shaft 154 against rotation about the axis thereof.

If the pressing portion 181 is pressed toward the negative side in the X-axis direction as indicated by an arrow in FIG. 7I, the neodymium magnet 179 is moved away from the hexagonal portion 154b, thereby releasing the roller shaft 154 to freely rotate. In other words, when the support bars 150 and the cassette 30 are coupled to each other, the substrate transfer device 10 controls the movement of the support bars 150 so as to press the pressing portion 181, thereby releasing the locking of the roller shaft 154.

If the pressing of the pressing portion 181 is released or if the support bars 150 and the cassette 30 are disconnected from each other, the neodymium magnet 179 is moved toward the positive side in the X-axis direction under the restoring force of the compression spring 180. Thus, the neodymium magnet 179 attracts the hexagonal portion 154b and locks the roller shaft 154 against rotation.

While the hexagonal portion 154b having a hexagonal shape was taken as an example herein, the shape of the roller shaft 154 is not limited to the hexagonal shape but may be other shapes as long as the roller shaft 154 can be fitted and locked to the neodymium magnet 179.

By using the neodymium magnet 179 in this manner, the roller shaft 154 is released to freely rotate when the support bars 150 and the cassette 30 are coupled to each other. The roller shaft 154 is locked against rotation when the coupling between the support bars 150 and the cassette 30 is released. This makes it possible to reliably prevent unnecessary displacement of the substrate 100 during transfer of the substrate 100.

In the lock mechanisms of the present embodiment shown in FIGS. 7A through 7I, the locking is automatically performed under the tension of, e.g., the tension spring 177 (see FIG. 7E), when the support bars 150 and the cassette 30 are kept disconnected from each other. The locking is forcibly released if the support bars 150 and the cassette 30 are coupled to each other. Accordingly, it is possible to reliably prevent unnecessary displacement of the substrate 100 during transfer of the substrate 100 when the support bars 150 and the cassette 30 are kept disconnected from each other.

The configuration examples of the lock mechanisms shown in FIGS. 7A through 7I are nothing more than examples in configuration and are not intended to limit the method of realizing them. The respective configuration examples may be appropriately combined with each other.

The operation described with reference to FIG. 6 and the lock mechanisms shown in FIGS. 7A through 7I are to prevent displacement of the substrate 100 in the X-axis direction. It may be possible to take a measure for holding the substrate 100 in an appropriate position in the Y-axis direction.

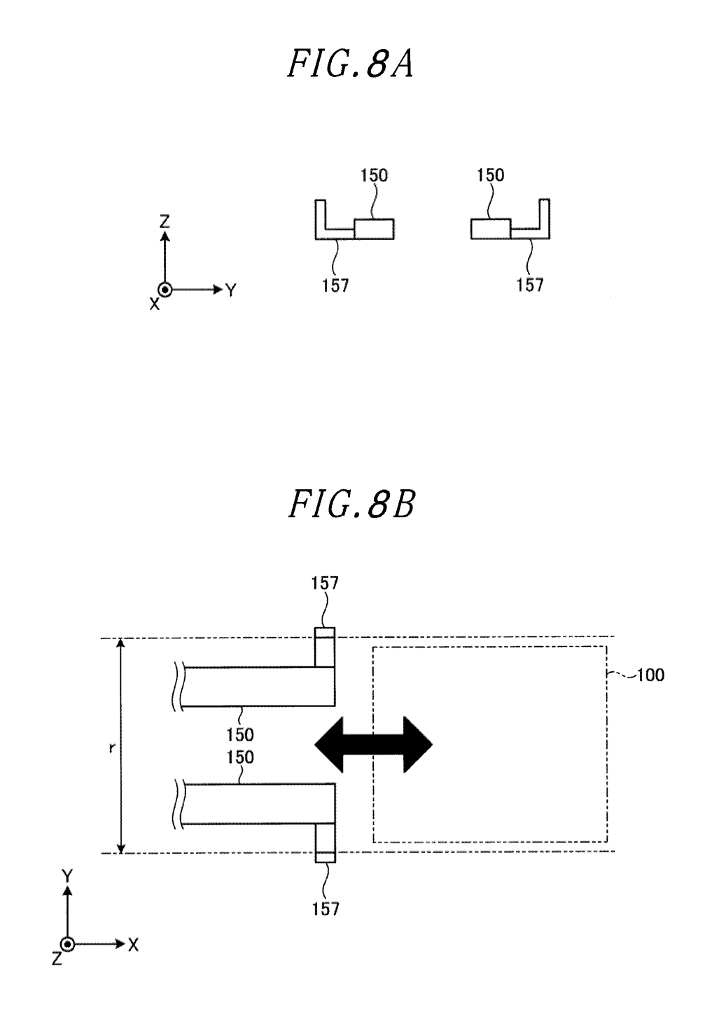

This can be realized by, e.g., employing a guide member for guiding the side surface of the substrate 100 toward an appropriate position. In this regard, description will be made with reference to FIGS. 8A and 8B.

FIG. 8A is a schematic diagram showing the support bars 150 each having a guide member 157, which is seen from the positive side in the X-axis direction. FIG. 8B is a schematic diagram showing the support bars 150 each having the guide member 157, which is seen from the positive side in the Z-axis direction.

As shown in FIG. 8A, the hand 15 of the present embodiment includes the guide members 157 having, e.g., an L-like cross-sectional shape. The guide members 157 are provided in the tip end portions of the support bars 150. By providing the guide members 157, as illustrated in FIG. 8B, the hand 15 of the present embodiment can accommodate the substrate 100 within a range r in the Y-axis direction during the unloading/loading process. This makes it possible to smoothly transfer the substrate 100 to a substrate processing unit.

While FIGS. 8A and 8B illustrate an example in which the guide members 157 are provided in the tip end portions of the support bars 150, the attachment positions of the guide members 157 are not limited thereto. As an alternative example, the guide members 157 may extend along the entire length of the side surfaces of the support bars 150.

Likewise, the shape of the guide members 157 is not limited to the L-like cross-sectional shape. Moreover, a member capable of smoothly guiding the substrate 100, such as roller or a bearing, may be used in combination.

As described above, the substrate transfer hand and the substrate transfer device including the substrate transfer hand, in accordance with the present embodiment, include the first driven roller which is rotated by the drive mechanism of the cassette when the substrate transfer hand is coupled to the cassette along the substrate unloading/loading direction.

With the substrate transfer hand and the substrate transfer device including same, it is possible to place the substrate on the hand and transfer the substrate without having to put the hand into the cassette.

While the fork-shaped hand is provided with a pair of support bars in the embodiment described above, the present invention is not limited thereto. As an alternative example, a fork-shaped hand having three or more support bars may be employed in the present invention disclosed herein.

While a glass substrate for a liquid crystal panel has been taken as an example of the substrate to be transferred in the embodiment described above, it goes without saying that the substrate may include all kinds of thin plates such as a semiconductor wafer and the like.

While the preferred embodiment of the present invention has been described above, the present invention is not limited to this embodiment but may be modified or changed in many different forms without departing from the scope of the invention defined in the claims.

What is claimed is:

1. A fork-shaped substrate transfer hand for unloading and loading a substrate with respect to a cassette and transferring the substrate, the substrate transfer hand comprising:
a first driven roller configured to be rotated by a drive mechanism provided in the cassette when the hand is coupled to the cassette along a substrate unloading/loading direction.

2. The substrate transfer hand of claim 1, further comprising:
a flat support bar configured to be coupled to the cassette;
a second driven roller provided to the support bar; and
a rotation transmitting unit for transmitting rotation of the first driven roller to the second driven roller such that the second driven roller is rotated in the same direction as the first driven roller.

3. The substrate transfer hand of claim 2, wherein the rotation transmitting unit is a belt.

4. The substrate transfer hand of claim 2, wherein the first driven roller and the second driven roller are arranged to transfer the substrate to a predetermined position on the support bar.

5. The substrate transfer hand of claim 1, wherein the first driven roller is driven by the drive mechanism under a magnetic action without making contact with the drive mechanism.

6. The substrate transfer hand of claim 2, wherein the rotation transmitting unit is arranged within the support bar.

7. The substrate transfer hand of claim 2, further comprising:
a sensor for detecting that the substrate is unloaded from the cassette by a specified amount, the support bar being disconnected from the cassette based on the detection result of the sensor.

8. The substrate transfer hand of claim 2, further comprising:
a guide for guiding the substrate in a specified region along a major surface of the support bar.

9. The substrate transfer hand of claim 3, further comprising:
a lock mechanism for automatically locking at least one of the first driven roller, the belt and the second driven roller and for releasing the locking if the support bar is coupled to the cassette.

10. The substrate transfer hand of claim 9, wherein the lock mechanism includes an electromagnetic brake for generating a braking force to lock the first driven roller or the second driven roller.

11. The substrate transfer hand of claim 9, wherein the belt has a toothed surface,
the lock mechanism includes a clasp formed to engage with the toothed surface of the belt, and
the belt is locked as the clasp comes into engagement with the toothed surface of the belt.

12. The substrate transfer hand of claim 9, wherein the first driven roller or the second driven roller includes a rotating shaft having a thick shaft portion with a greater diameter and a thin shaft portion with a smaller diameter,
the lock mechanism includes slide bushes through which the rotating shaft extends, the slide bushes having a through-hole circumscribing the thick shaft portion, and
the rotating shaft is braked to lock the first driven roller or the second driven roller as the slide bush is moved from the thin shaft portion to the thick shaft portion along the rotating shaft.

13. The substrate transfer hand of claim 9, wherein the first driven roller or the second driven roller has an outer circumferential surface and a locking hole formed on the outer circumferential surface,
the lock mechanism includes a pin cylinder provided with a pin, and
the first driven roller or the second driven roller is locked as the pin of the pin cylinder is fitted into the locking hole.

14. The substrate transfer hand of claim 9, wherein the lock mechanism includes a pair of latches for gripping the first driven roller or the second driven roller therebetween to lock the first driven roller or the second driven roller.

15. The substrate transfer hand of claim 9, wherein the lock mechanism includes a neodymium magnet,
the first driven roller or the second driven roller has a rotating shaft formed to engage with the neodymium magnet, and
the first driven roller or the second driven roller is locked as the neodymium magnet is attracted toward the rotating shaft of the first driven roller or the second driven roller.

16. A substrate transfer hand for unloading and loading a substrate with respect to a cassette, in cooperation with a conveyor unit having a drive mechanism, and transferring the substrate, the substrate transfer hand comprising:
a support bar including a first driven roller configured to be rotated by the drive mechanism when the hand is coupled to the cassette along a substrate unloading/loading direction; and
a second driven roller configured to be rotated by the first driven roller in the same direction as the first driven roller.

17. A substrate transfer device comprising the substrate transfer hand of claim 1.
